(19) United States
(12) Patent Application Publication
(10) Pub. No.: US 2020/0261923 A1
(43) Pub. Date: Aug. 20, 2020

(54) METHOD AND DEVICE FOR SORTING FIBERS IN SUSPENSION IN AN AEROSOL THROUGH THE COMBINATION OF ELECTROSTATIC AND GRAVITATIONAL FORCES

(71) Applicant: COMMISSARIAT A L'ENERGIE ATOMIQUE ET AUX ENERGIES ALTERNATIVES, Paris (FR)

(72) Inventors: Simon CLAVAGUERA, Grenoble (FR); Michel POURPRIX, Montlhery (FR); Francois TARDIF, Lans Ev Vercors (FR)

(73) Assignee: COMMISSARIAT A L'ENERGIE ATOMIQUE ET AUX ENERGIES ALTERNATIVES, Paris (FR)

(21) Appl. No.: 16/753,993

(22) PCT Filed: Oct. 11, 2018
(86) PCT No.: PCT/EP2018/077801

§ 371 Date: Apr. 6, 2020

(30) Foreign Application Priority Data
Oct. 12, 2017 (FR) 1759587

(51) Int. Cl. B03C 3/08; B03C 3/47; B03C 3/155; G01N 15/02

(52) U.S. Cl. CPC B03C 3/08; B03C 3/47; G01N 2015/0046; G01N 15/0266; G01N 2015/0288; B03C 3/155

(57) ABSTRACT

The invention consists of a continuous sorting method and device which highlights the trajectory differences to which fibers of different form factors and particles charged under the joint influence of electrical and gravitational forces could be subjected. Thus, according to the sorting method, the conditions exploit this difference in order to recover/collect the fibers separated from the non-fibrous particles present in the same initial aerosol or to sort fibers exhibiting different form factors.

### TECHNICAL FIELD

The present invention relates to the field of the sorting of micro-and nano-fibers in an aerosol likely to contain the fibers of different sizes and possibly non-fibrous particles.

It relates more particularly to the production of electrodynamic devices for implementing such a sorting.

The present invention aims to increase the selectivity of the analyzers and of the devices for sorting fibrous particles of mineral origin (ceramics, glass, carbon nanotubes, metal nanowires, etc.), of organic origin or of biological origin (cells, bacteria, viruses, etc.), in real time.

It also aims to augment the performance levels of the existing methods for continually detecting and measuring, in real time, concentrations of asbestos fibers implemented notably in very dusty environments.

It also aims to improve the performance levels of the conventional methods of filter collection followed by post-analysis by microscopy.

One of the main applications targeted by the invention is the sorting of asbestos fibers in an aerosol likely to contain any particles, any non-fibrous particles.

“Asbestos fibers” are defined and characterized by the World Health Organization as follows:
“WHO” asbestos fibers characterized by L≥5 μm, 0.2<d<3 μm, L/d ratio ≥3,
short asbestos fibers (SAF) with 0.5<L<5 μm, d<3 μm, L/d≥3,
fine asbestos fibers (FAF) with L≥5 μm, d<0.2 μm and L/d≥3,
where L and d respectively represent the length and the diameter.

Although described hereinafter preferentially with reference to the application of selection of asbestos fibers, the invention applies to the sorting of any type of fibrous particles and for various applications.

### STATE OF THE ART

The regulations concerning the modalities for measuring the level of dust, notably of asbestos fibers, is clear, strict and increasingly restrictive. For example in France, the regulation has recently lowered the occupational exposure limit value (OELV) to 10 fibers per liter of air inhaled over eight working hours.

Measuring the concentration in terms of number of fibers in the air has hitherto been done by sampling on a membrane or by means of direct reading devices.

Whatever the sampling mode, a major problem is always encountered in the case of very dusty environments. This relates to the difficulty in exclusively counting the fibers because, particles of all kinds and origins (oil, cement, paints, etc.) are also present and can disturb or mask the measurements.

Indeed, in particular the cleansing and asbestos removal operations during demolition or renovation processes (buildings, rolling stock, etc.) implement surfaces on which multiple materials have been deposited over very long periods. It is therefore particularly difficult to discriminate a small number of fibers in an environment very strongly charged with particles.

Given the low number of fibers to be counted, a certain number of devices described in the literature are no longer relevant today, in particular because of their detection limitations.

In aerosol physics, it is known that, in the absence of electrical field in a unipolar ionized space, the aerosol particles in suspension in this space will acquire an electrical charge through the mechanism of electrical charge by diffusion of unipolar ions on their surface.

A state of balance will then be established, the charge acquired by the particles depending notably on the product Ni*t, where Ni represents the ion concentration and t the dwell time of the particles in the ionized space.

Ultimately, for a given product Ni*t, the result thereof is that the electrical mobility acquired by these particles, in a mode of charge solely by ion diffusion, is all the greater when the articles are finer. This is illustrated notably by FIG. 15.4 on page 330 of publication [1].

By contrast, it has been widely proven that the result is the reverse for particles in the form of fibers charged only by unipolar ion diffusion. Thus, the publication [2] shows that, for fibers of given diameter, the longer the fibers, the greater their electrical mobility.

This property is exploited to classify carbonized fibrous aerosols: study [3]. This study was added to a few years later by the same team by describing therein carbon fibers and glass fibers: see publication [4]. In particular, they were interested in the electrical mobility of carbon fibers of a diameter equal to 3.74 μm, as a function of their length, for a product Ni*t equal to 1.9*10⁷ s/cm³.

The authors of the publication [5] have also demonstrated the abovementioned reverse result for fibers by calculation. More specifically, to arrive at this result, these authors calculated the electrical mobility of fibrous particles of a diameter equal to 1 μm for different fiber lengths equal respectively to 3 μm, 10 μm and 20 μm, charged only by unipolar ion diffusion. They also demonstrate that, with constant fiber diameter, the electrical mobility of the fibers is all the higher when their length is great.

Furthermore, the authors of this publication [5] show that it is possible to make practical use of this particular feature to separate the fibers from the other particles in suspension in an aerosol. To do this, they recommend the serial use of two separators, namely a first aerodynamic separator to perform a selection according to the size of the particles by centrifugation, sedimentation or inertia, and, downstream of the first separator, a second separator, but of electrostatic nature, for selecting the fibers according to their length.

Earlier works highlight the same physical principle and describe the separation and the deposition of fibrous particles on a porous substrate: see publications [6] and [7] by the same author.

Other works which implement a physical principle distinct from those described previously, have addressed the same issue of separation of fibrous particles. In these other works, the particles are neutralized electrically by a radioactive source and only bear polarization in an electrical field (dielectrophoresis) makes it possible to classify them according to their length. The family of these devices bears the name of “Baron fiber classifier” in referring to the works of the team of the researcher P. A. Baron: see publication [8].

In a Baron fiber classifier, the conductivity of the fibers is a prerequisite to allow for an effective sorting. Nevertheless, it would seem that, for significant moisture levels, typically higher than 30%, the water condensed on the surface of the fibers produces a conductive layer which would make it possible to mitigate the problems of non-conductive fibers: see publication [9].

An evaluation of this kind of device was carried out by the same team of the researcher Baron, by simulation in computational fluid dynamics (CFD): see publication [10]. It emerges from this assessment that this type of device is limited to the short fibers.

Finally, a recent enhancement to this type of device was proposed to generate large quantities of sorted fibers for toxicology studies: see publication [11].

The U.S. Pat. No. 7,931,734B2 discloses a system comprising two differential electrical mobility analyzers (DMA) in series, which makes it possible, according to the inventors, to separate fibers and particles according to their charges. As a reminder, a DMA is an instrument capable of separating particles according to their electrical mobility by selecting, for a given voltage, a given electrical mobility class.

The patent application WO 2013/058429A1 and patents KR 101558480B1 and KR101322689B1 disclose fiber separation devices in the general toroidal form, which implement the process of charging aerosols by unipolar ion diffusion. In these documents, it is mentioned that the electrical effects become predominant in the toroidal geometry described because the rate of flow decreases with distance away from the axis of the device whereas the rate of drift due to the electrical field remains constant.

In the general field of electrically charged particles, works have been conducted on the use of other forces in addition to an electrical field, for the driving and the separation of the particles.

First of all, the field of gravity was exploited in addition to an electrical field.

Thus, the U.S. Pat. No. 6,012,343B discloses a DMA analyzer of radial flow type which serializes two so-called circular electrical mobility selectors and in which the extraction of the particles from the upstream selector to the downstream selector is performed by a slit by exploiting both the electrical and gravity fields.

The combined use of a centrifugal force and of an electrical field has also been implemented.

The first instrument relating to this combined centrifugal force/electrical field use is disclosed in the patent JP07055689, the results of which are given in the publication [12].

In this instrument, the electrically charged particles circulate by laminar flow between two concentric cylinders revolving at the same velocity. To ensure that the particles do indeed revolve at the same velocity as the cylinders, which is essential for optimal operation, the longitudinal air flow is channeled by insulating spacer guides positioned between the two cylinders. Another function of these spacers is to keep the cylinders mutually mechanically coaxial. An electrical field is established between the cylinders, such that the particles are subjected on the one hand to a centrifugal force proportional to their mass, and on the other hand to a centripetal force proportional to their electrical charge. The particles which leave the cylinders thus have the same combined charge/mass characteristic. By measuring a charge of a particle, it is therefore possible to deduce its weight therefrom. The other particles have been deposited in the equipment.

This type of instrument is marketed by the company KANOMAX under the name “Model 3602 APM-II”.

An enhancement has been made to this analysis instrument: see publication [13]. The enhancement consists in revolving the inner cylinder slightly faster than the outer cylinder to better radially balance the electrical and centrifugal forces.

The apparatus marketed by the company CAMBUSTION under the name “Model Centrifugal Particle Mass Analyser” implements this enhancement.

In fact, from studying the state of the art, it emerges that no device has been proposed that makes it possible to effectively and simply sort fibers with respect to one another or to non-fibrous particles contained in an aerosol.

Now, there is a need for such a device in order to continually sort fibrous particles from one another and from non-fibrous particles (by minimizing the depositions of particles of interest on the walls) in the context of industrial methods or to increase the selectivity of existing real-time fiber analyzers, notably by reducing the part of detection linked to the non-fibrous particles likely to mask the counting of the fibers.

The general aim of the invention is then to at least partly address this need.

### SUMMARY OF THE INVENTION

To do this, the subject of the invention is first of all a method for sorting, preferably continuously, fibers in suspension in an aerosol likely to contain fibers of different sizes and possibly non-fibrous particles, comprising the following steps:
a/ charging of the particles in suspension in the aerosol, by unipolar ion diffusion;
b/ application of an electrical field between two electrically conductive flat surfaces arranged substantially horizontally; the electrical field being directed in such a way that it exerts an electrostatic force on the charged particles, in opposition to the gravitational force;
c/ introduction of an aerosol flow from an input of a height corresponding to at least a part of the height of the space delimited between the two flat surfaces; the flow of the flow of air being non-turbulent in the space between flat surfaces; the flow of air circulating from and/or around the input to one or more outputs;
d/ recovery of the part of air flow charged with fibers and circulating at at least one of the outputs in the upper part of the space, or collection of the fibers on the flat surface on top which is in the form of a filtering membrane; the fibers recovered in the part of air flow or collected on the filtering membrane being sorted from the particles exhibiting a smaller form factor or that are non-fibrous initially present in the aerosol.

According to one advantageous embodiment, the method further comprises a step d′/ simultaneous with the step d/, whereby the part of air flow charged with non-fibrous particles and circulating at at least one of the outputs in the lower part of the space is recovered, or non-fibrous particles are collected on the flat surface below which is in the form of a filtering membrane.

Faced with the problem of separating asbestos fibers in an aerosol containing any particles, non-fibrous and not relevant to the existing fiber analyzers, the inventors shrewdly thought to stress the difference in trajectories to which fibers of different form factors and charged particles under the combined influence of electrical and gravitational forces could be subject.

Thus, they created the conditions to exploit this difference in order to recover/collect the fibers separated from the non-fibrous particles present in the same initial aerosol or to sort the fibers exhibiting different form factors.

According to a variant, with flat surfaces which are rectangular flat plates:
the step c/ is performed by introduction of the aerosol into an input slit arranged in the space between plates and by circulation of a longitudinal flow of filtered air introduced on either side of the slit co-current with the aerosol flow;
the step d/ is performed by recovery of the part of air flow charged with fibers in an output channel delimited between the top flat plate and a flow-separating wall arranged between the two flat plates;
if necessary, the step d′/ is performed by recovery of the part of the air flow charged with non-fibrous particles in an output channel delimited between the lower flat plate and a flow-separating wall arranged between the two flat plates.

According to another variant, with flat surfaces which are solid circular plates:
the step c/ is performed by introduction of the aerosol into an input slit arranged in the space between plates and by circulation of a radial flow of aerosol toward the center of the surfaces;
the step d/ is performed by recovery of the part of the air flow charged with fibers in an output duct produced in the axial extension in the circular plate on top thereof;
if necessary, the step d′/ is performed by recovery of the part of the air flow charged with non-fibrous particles in an output duct produced in the axial extension in the circular plate below the latter.

According to another variant, with at least the flat surface on top which is a circular filtering membrane:
the step c/ is performed by introduction of the aerosol into an input slit arranged in the space between plates or in all the space between plates and by circulation of a radial flow of aerosol toward the center of the surfaces;
the step d/ is performed by collection of the fibers on the filtering membrane, the air flow without fibers collected being recovered in an output orifice above the filtering membrane;
if necessary, the step d′/ is performed by collection of the non-fibrous particles on a filtering membrane, the air flow without particles collected being recovered in an output orifice below the filtering membrane.

According to another variant, with flat surfaces which are the underside faces of two openwork disks with concave circular edge, arranged horizontally coaxially to one another defining a space between them; the input being a duct produced in the axial extension of the outer disk above the latter; the output being a duct produced in the axial extension of the inner disk above the latter; the underside face of the inner disk being at least partly a filtering membrane:
the step b/ is performed by application of the uniform electrical field between the two disks, the uniform electrical field being directed from bottom to top between the underside face of the outer disk and the underside face of the inner disk;
the step c/ is performed by introduction of the aerosol from the input duct; the flow of the air flow being non-turbulent in the space between the two disks; the air flow circulating from the input duct to the output duct;
the step d/ is performed by collection of the fibers on the filtering membrane; the fibers collected on the filtering membrane being separated from the non-fibrous particles initially present in the aerosol and having fallen through gravity in the space between faces below.

Another subject of the invention is a device for implementing the sorting method which has just been described, comprising:
two electrically conductive flat surfaces arranged substantially horizontally;
means for applying an electrical field between the two flat surfaces, from the bottom to the top;
means for introducing an aerosol flow of fibers in suspension in an aerosol likely to contain non-fibrous particles, from an input of a height corresponding to at least a part of the height of the space delimited between the two flat surfaces;
means for recovering the part of air flow charged with fibers and circulating at at least one of the outputs in the upper part of the space, or collection of the fibers on the flat surface above which is in the form of a filtering membrane.

According to an advantageous embodiment, the device further comprises means for recovering the part of air flow charged with non-fibrous particles and circulating at at least one of the outputs in the lower part of the space, or collection of the particles on the flat surface below which is in the form of a filtering membrane.

According to one embodiment, the two flat surfaces are rectangular flat plates, the input being a slit arranged in the space between plates, the output being a channel delimited between the top flat plate and a flow-separating wall arranged between the two flat plates.

According to another variant, the flat surfaces are solid circular plates, the input being a circular slit arranged in the space between plates, the output being a duct produced in the axial extension in the top circular plate.

Advantageously, the device can further comprise a duct for recovering the part of the flow containing the non-fibrous particles, the duct produced in the axial extension in the bottom circular plate.

According to another variant, the flat surfaces are circular surfaces, at least the top one of which comprises a filtering membrane; the input being a circular slit arranged in the space between circular surfaces, the output being a duct produced in the axial extension above the filtering membrane.

According to another variant, the flat surfaces are circular surfaces, at least the top one of which comprises a filtering membrane; the input being composed of all the space between circular surfaces, the output being a duct produced in the axial extension above the filtering membrane.

According to another variant, the flat surfaces are the bottom faces of two openwork disks with concave circular edge, arranged horizontally coaxially to one another defining a space between them; the input being a duct produced in the axial extension of the outer disk on top of the latter; the output being a duct produced in the axial extension of the inner disk on top of the latter; the bottom face of the inner disk being at least partly a filtering membrane.

A final subject of the invention is the use of a method described above and/or of a device described previously for the detection and measurement of concentration in terms of number of fibers, in particular of asbestos fibers, in air, notably in a dusty environment.

The method and the device according to the invention are particularly suited to the detection and measurement of concentrations of sufficiently heavy fibers, for instance WHO asbestos fibers. However, the method and the device according to the invention can be used for the detection and measurement of concentrations of short asbestos fibers (SAF) and/or of fine asbestos fibers (FAF).

It is possible to use the method and/or perform the integration of the device according to the invention upstream of a real time system for measuring concentrations of asbestos fibers in air, notably to continually measure the concentrations and their variations over time.

### DETAILED DESCRIPTION

Other advantages and features will become more apparent on reading the detailed description, given in an illustrative and nonlimiting manner, with reference to the following figures in which:

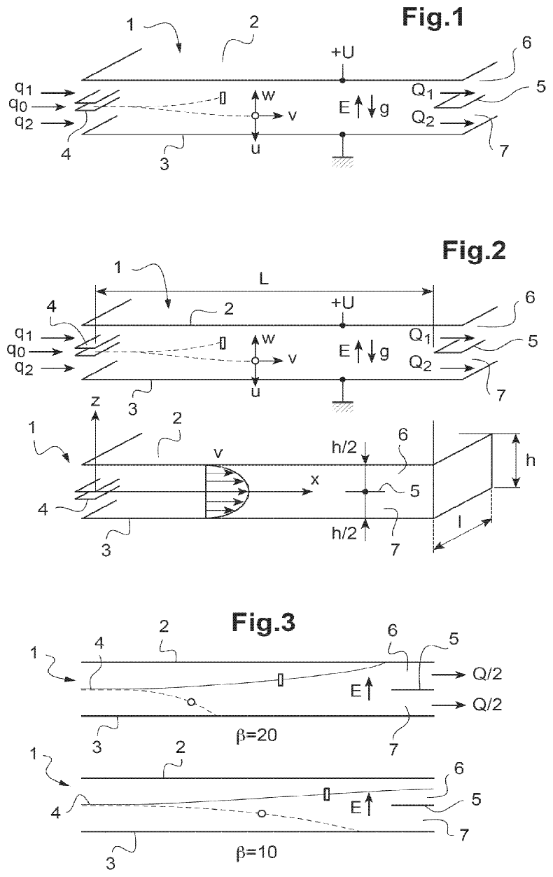

FIG. 1 is a schematic view in longitudinal cross section of a fiber sorting device with flat plates according to the invention;

FIG. 2 is a repeat of FIG. 1 indicating the dimension and velocity parameters involved in calculating trajectories of particles circulating between the flat plates;

FIG. 3 schematically represents, as a function of different slenderness values (length/diameter ratio), the different trajectories followed by the fibers circulating in the device of FIG. 1;

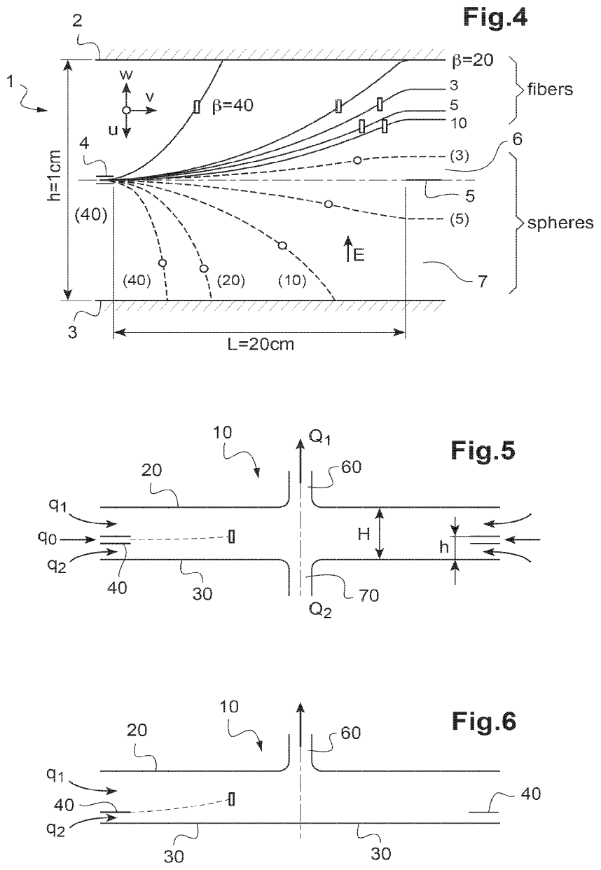

FIG. 4 represents a summary, as a function of different slenderness values, of the different trajectories followed both by the fibers and the non-fibrous particles of equivalent volume contained in one and the same aerosol, circulating in the device of FIG. 1;

FIG. 5 is a schematic view in longitudinal cross section of a first variant of a device;

FIG. 6 is a schematic view in longitudinal cross section of a second variant of a device;

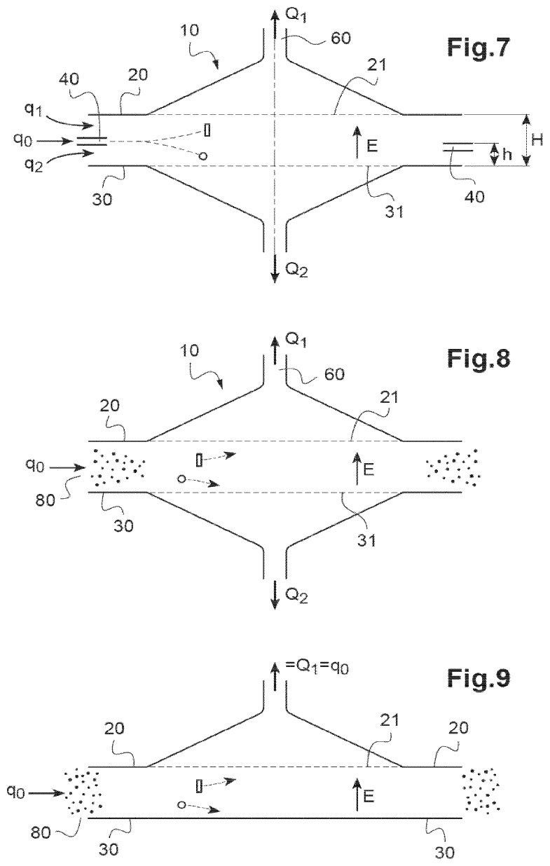

FIG. 7 is a schematic view in longitudinal cross section of a third variant of a device;

FIG. 8 is a schematic view in longitudinal cross section of a fourth variant of a device;

FIG. 9 is a schematic view in longitudinal cross section of a fifth variant of a device;

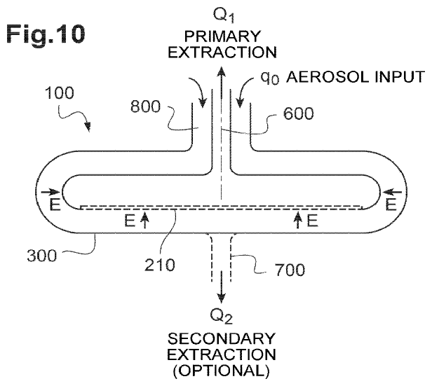

FIG. 10 is a schematic view in longitudinal cross section of a sixth variant of a device.

Throughout the present application, the terms “vertical”, “bottom”, “top”, “low”, “high”, “below”, “above”, “height” should be understood with reference to a separation device according to the invention arranged horizontally or vertically.

Likewise, the terms “input”, “output”, “upstream” and “downstream” should be understood with reference to the direction of the flow of aerosol in a device according to the invention. Thus, the input designates a zone of the device through which the aerosol containing the fibers and the non-fibrous particles is introduced whereas that of output designates that through which the air flow charged only with fibers is discharged.

For clarity, the same elements of the sorting devices according to the examples illustrated are designated by the same numeric references.

FIG. 1 shows an example of device 1 for sorting fibers and, if appropriate, non-fibrous particles contained initially in an aerosol.

It is specified that previously, before the introduction of the aerosol into the device 1, the particles of the aerosol are charged negatively by unipolar ion diffusion. Within the context of the invention, the opposite, i.e. positively-charged particles, is quite conceivable.

The sorting device 1 first of all comprises two parallel flat plates 2, 3, arranged horizontally. These plates 2, 3 are electrically conductive.

At a longitudinal end of the plates 2, 3, there is arranged an input slit 4, in the middle of the space between plates, that is to say the middle of the slit 4 is at half the height h of the space between plates 2, 3. The slit 4 can for example be produced by two plates, also flat and mutually parallel, but over a height much lesser than the space between plates 2, 3.

At the other longitudinal end, there is arranged a separation wall 5, also at the middle of the space between plates 2, 3. This wall 5 therefore delimits, with the plate on top 2, a channel 6, while it delimits, with the plate below 3, a channel 7.

An electrical field E is generated, preferably uniform and preferably of constant intensity, between the plates 2, 3, the field E being directed from bottom to top. For this, for example, the bottom plate 3 is brought to the zero potential, whereas the top plate 2 is at the potential +U. In the context of the invention, it is perfectly possible to envisage the reverse, that is to say particles positively charged with an electrical field in the device equal to −U.

A longitudinal flow of filtered air with non-turbulent flow is introduced from the side of the slit 4, into the space between plates 2, 3. The filtered air flow is separated into a flow q1 between the slit 4 and the plate on top 2 and a flow q2 between the slit 4 and the plate below 3.

The aerosol is then introduced through the slit 4, at a flow rate qo.

The electrically charged particles are therefore subjected to the electrical field E, which tends to draw them toward the top plate 3, unless they are too dense, in which case they will tend to be deposited on the bottom plate 2 under the action of the gravity field g.

Thus, in its travel between the plates, any particle, including a fibrous one, will be subjected to these two antagonistic force fields, field of gravity g and electrical field E.

Each particle, fibrous or not, will therefore be subjected to two opposing transverse velocities:
an upward velocity due to the electrical field denoted w, such that w=Z*E, where Z is the electrical mobility of the particle,
a downward velocity due to the field of gravity denoted u, such that u=τ*g, where τ is the relaxation time of the particle, and g is the Earth's field of gravity.

The trajectory of a particle will therefore result from the composition of these two transverse velocities u and w on the one hand, of its longitudinal velocity v in the non-turbulent flow on the other hand.

For a fixed geometry and flow rate, an appropriate value of the field E can therefore direct the fibers and the fine particles that are highly electrically mobile and not subject to gravity, into the top part of the space between plates 2, 3, and direct the non-fibrous particles into the bottom part 7 of this space, above all the large particles, which have little electrical mobility and are subject to gravity.

It is therefore possible to recover, in the output channel 6, the fibers separated and borne by the air flow at the flow rate Q1.

In parallel, it is possible to recover, in the output channel 7, the fibers exhibiting the lowest form factor or the non-fibrous particles borne by the air flow at the flow rate Q2.

The sum of the input flow rates q₀, q₁ and q₂ equals the sum of the output flow rates Q₁ and Q₂.

Thus separated from the fibers, the large particles can no longer mask the count of the fibers for the asbestos fiber measuring application.

The inventors have corroborated, by calculations presented hereinbelow, the separation between fibers and non-fibrous particles by the combined action of electrical force resulting from a field E created between flat plates, and the Earth's field of gravity g.

In the calculations, the case of carbon fibers is considered, specifically those which were used in the experiments mentioned in the publication [3], of 3.74 μm diameter, charged by unipolar ion diffusion with a product Ni*t=1.9.10⁷ s/cm³. The advantage of using carbon fibers is that their electrical characteristics have been particularly well studied by the authors of the publication. Another advantage is also deliberately choosing conditions conducive to revealing the action of the field of gravity relative to the action of the electrical field.

The trajectory of a particle is obtained by composing the velocities u, v, w, in which:

$$\begin{matrix}u = {τ}^{*} g & \\ w = {Z}^{*} E , & \\ i . e . & \\ w - u = \frac{dz}{dt} = Z \cdot E - τ \cdot q & ( 1 ) \\ v = \frac{dx}{dt} = \frac{3}{2} * \frac{Q}{l * h} * ( 1 - 4 * \frac{{z}^{2}}{{h}^{2}} ) & ( 2 )\end{matrix}$$

in which
τ represents the relaxation time of a particle, in seconds (s)
g is the acceleration of gravity, in m/s^{2;}
Z is the electrical mobility of the particle, in m²/(V*s);
E is the electrical field in V/m;
Q is the air flow rate driving the particle in m³/s;
l is the width of the air flow circulation channel;
h is the air flow circulation height.

By eliminating dt, in the equations (1) and (2), the following is obtained:

$$\frac{3}{2} * \frac{Q}{l * h} * ( 1 - 4 * \frac{{z}^{2}}{{h}^{2}} ) * d z = ( Z * E - T * g ) * d x$$

In other words by performing the integration

$$\frac{3}{2} * \frac{Q}{l * h} * {\int }_{0}^{z} ( 1 - 4 * \frac{{z}^{2}}{{h}^{2}} ) * d z = {\int }_{0}^{x} ( Z * E - τ * g ) * dx$$

Hence the final equation (3) as follows:

$$\frac{3}{2} * \frac{Q}{l * h} * ( z - \frac{4}{3} * \frac{{z}^{3}}{{h}^{2}} ) = ( Z * E - τ * g ) * x$$

To calculate the relaxation time τ_{f} of a fiber, the equation (4) is used:

$${τ}_{f} = \frac{ρ * {d}^{′2}}{18 * η * {χ}_{f}}$$

in which:
ρ represents the density equal to 1.832.10³ kg/m³ for carbon fibers;
d′=d*(1.5*β)^{1/3} and d is equal to 3.74 μm;
η represents the viscosity of air equal to 1.81*10⁻⁵ Pa·s;
χ_{f} is the form factor dependent on β;
β is the slenderness (ratio between fiber length and diameter).
   By taking into account the experimental data from the publication [3] and according to the equation (4), the table 1 below of fiber characteristics is obtained:

| β | χ_{f} | Z_{f} in m²/(V*s) | τ_{f} in s |
|---|---|---|---|
| 10 | 1.269 | 7.97*10^{—8} | 3.77*10^{—4} |
| 20 | 1.541 | 11.27*10^{—8} | 4.93*10^{—4} |

It is specified that the experimental data used are valid for Nᵢ*t equal to 1.9*10¹³ ions*s/m³, where Nᵢ is the concentration of unipolar ions and t is the dwell time.

To calculate the electrical field E which allows fibers of factor β equal to 20, to arrive at the top of the space between plates, i.e. closest to the top plate, with x=L, the equation (3) for

$$z = \frac{h}{2} ,$$

which gives:

$$E = \frac{\frac{Q}{2 * l * L} + {τ}_{f} * g}{{Z}_{f}}$$

with Q representing the flow rate equal to 2 liters per min; 1=5 cm, L=20 cm, τ_{f}=4.93*10⁻⁴s, Z_{f}=11.27*10⁻⁸ m²/(V*s) and g=9.81 m/s², an electrical field value E equal to 5.76*10⁴ V/m is obtained.

By using this value in the equation (3) above, all the elements are there to find the trajectory of the fibers of factor β equal to 20.

For the same value E, it is also possible to find all the elements to find the trajectory of the fibers of factor β equal to 10.

It is possible to proceed and do the same calculations for a volume-equivalent sphere (the indices “se” hereinbelow corresponding to an equivalent sphere).

Let dₛₑ be the volume diameter of a sphere equivalent to a fiber of diameter d and of length l_{f}, then the following relationship applies:

$$\frac{π * {d}^{2}}{4} * lf = \frac{4}{3} * π * {( \frac{d s e}{2} )}^{3}$$

Then, with β which is the ratio between fiber length lf and diameter d, the equation (4) applies:

dₛₑ=d*(1.5*β)^{1/3}.

For the calculation of the relationship time of the sphere, the equation (5) is used:

$${τ}_{s e} = \frac{ρ * {d}_{s e}^{2}}{18 * η * {χ}_{s e}}$$

with χₛₑ equal to 1.

For the calculation of electrical mobility of the spheres, the publication [1] makes it possible to determine it for a product Nᵢ*t equal to 10¹³ ions*s/m³.

It is possible to extrapolate to assume conditions calculated for the fibers, i.e. with Nᵢ*t equal to 1.9*10¹³ ions*s/m³.

To do this, the expression (15.24) on page 325 of the publication [1] is used, which makes it possible to find a multiplying coefficient equal to 1.083.

The table 2 below of characteristics of the equivalent spheres is therefore obtained:

| β | dₛₑ in μm | χₛₑ | Zₛₑ in m²/(V*s) | τₛₑ in s |
|---|---|---|---|---|
| 10 | 9.24 | 1 | 4.52*10^{—8} | 4.78*10^{—4} |
| 20 | 11.63 | 1 | 4.48*10^{—8} | 7.59*10^{—4} |

The trajectory of these two types of particles, i.e. fibers and equivalent spheres, is illustrated in FIG. 3 respectively for β=20 and β=10.

It emerges from this FIG. 3 that the separation between this type of fiber and their equivalent spherical particles, in terms of volume and of mass, is therefore clearly established.

FIG. 4 illustrates the trajectories for the values of β respectively equal to 3, 5, 10, 20 and 40.

FIGS. 5 and 6 show variants of device 10 in which the rectangular flat plates are replaced by circular solid plates 20, 30 between which the aerosol and the filtered air are injected and circulate co-current according to a radial flow from the outside toward the center of the plates 20, 30.

In the variant of FIG. 5, the input is a circular slit 40 arranged in the space between plates 20, 30. The output through which the fibers are recovered is a duct 60 produced in the axial extension in the circular plate 20 on top. The non-fibrous particles that fall through gravity are, for their part, discharged through a duct 70 produced in the axial extension in the circular plate 30 below.

In the variant of FIG. 6, the input slit 40 is delimited by the circular plate below 30 and there is only a recovery of the fibers through the axial duct 60 on the plate on top 20.

It is possible to envisage arranging devices according to the variants of FIGS. 5 and 6 upstream of direct reading devices, the large, non-fibrous particles being eliminated.

FIGS. 7 to 9 show variants, in which the aerosol and the filtered air are injected and made to circulate, also circulating co-current according to a radial flow from outside toward the center but, instead of recovering the separated fibers in a duct 60 and if necessary the non-fibrous particles in a duct 70 as in FIGS. 5 and 6, the separated particles are collected on one or two filtering membranes 21, 31 which are electrically conductive (or insulating, but supported by conductive gratings).

In the variant of FIG. 7, a filtering membrane 21 is arranged as collection surface on top and a filtering membrane 31 is arranged as collection surface below. The electrical field E is applied between the two filtering membranes 21, 31 from bottom to top. The aerosol is injected radially into a circular slit 40 arranged in the space between membranes 21, 31. The separated fibers are collected on the membrane on top 21, the air transporting them being discharged through an output duct 60 produced in the axial extension above the filtering membrane 21. The non-fibrous particles that fall through gravity are collected on the membrane below 31, the air transporting them being discharged through an output duct 70 produced in the axial extension below the filtering membrane 31. As illustrated, the ducts 60, 70 are produced at the end of a solid truncated cone respectively above the top filtering membrane 21 and below the lower one 31.

The device of FIG. 8 is similar to that of FIG. 7, except that the aerosol is injected radially over all the height of the space 80 between the membranes 21, 31.

The device of FIG. 9 comprises a single filtering membrane 21 for the collection of the separated fibers with radial injection over all the height of the space 80 between the membrane 21 and the solid disk 30.

FIG. 10 shows a variant of device 100, which makes it possible to increase the separation of the fibers through the electrical force and the separation of the non-fibrous large particles through the field of gravity.

In this variant, the flat surfaces between which the electrical field is established are composed of the bottom face 210, of the disk 200, and of the top face of a disk 300 arranged coaxially horizontal one inside the other defining a space of constant thickness between them.

Each of these two disks 200, 300 is openwork and has concave circular edge.

The bottom face 210 of the bottom disk 200 is at least partly a filtering membrane.

The aerosol of charged particles is, here, introduced through a duct 800 produced in the axial extension of the outer disk 300 on the top of the latter then circulates in the space between disks 200, 300.

The separated fibers are collected on the membrane 210, the air transporting them being discharged through an output duct 600 produced in the axial extension above the filtering membrane 210. The output duct 600 can be coaxial to the input duct 800.

Optionally, the non-fibrous particles that fall through gravity can be discharged by the air in an output duct 700 produced in the axial extension of the outer disk 300 below the latter.

Other variants and enhancements can be made without in any way departing from the scope of the invention.

Thus, if, in the embodiments illustrated, the flow rate Q1 is shown equal to that of Q2 equal to the total flow rate divided by two Q2, it is perfectly possible to envisage having Q1 different from Q2 and from Q/2.

The same goes for q0, q1 and q2 which can be different from one another and also different from q/3.

Moreover, if, in all the examples illustrated, the flat surfaces are parallel with one another and define a space of constant thickness, it is perfectly possible to envisage implementing the invention with surfaces that are not parallel and therefore with a space of variable thickness.

The invention is not limited to the examples which have just been described; it is notably possible to combine with one another features of the examples illustrated within variants that are not illustrated.

### REFERENCES CITED

[1]: W. Hinds, “Aerosol Technology”, 2^{nd} Edition, 1999.
[2]: Zebel G., Hochrainer D., Boose C., “A sampling method with separated deposition of fibres and other particles”, J. Aerosol Sci., 8:205-213 (1977).
[3]: Chen B. T., Yeh H. C., Hobbs C. H., “Size Classification of Carbon Fiber Aerosols”, Aerosol Sci. Technol., 19:109-120 (1993).
[4]: Chen B. T., Yeh H. C., Johnson N. F., “Design and use of a virtual impactor and an electrical classifier for generation of test fiber aerosols with narrow size distributions”, J. Aerosol Sci., 27(1):83-94 (1996).
[5]: Han R. J., Moss O. R., Wong B. A., “Airborne Fiber Separation by Electrophoresis and Dielectrophoresis: Theory and Design Considerations”, Aerosol Sci. Technol., 21:241-258 (1994).
[6]: Griffiths W. D., “The selective separation of aerosol particles of different shapes”, J. Aerosol Sci., 18(6):761-763 (1987).
[7]: Griffiths W. D., “The shape selective sampling of fibrous aerosols”, J. Aerosol Sci., 19(6):703-713 (1988).

[8]: Baron P. A., Deye G. J., Fernback J., “Length separation of fibers”, Aerosol Sci. Technol., 21:179-192 (1994).
[9]: Lilienfeld, P. “Rotational Electrodynamics of Airborne Fibers”, J. Aerosol Sci. 4: 315-322 (1985).
[10]: Deye G. J., Gao P., Baron P. A., Fernback J., “Performance Evaluation of a Fiber Length Classifier”, Aerosol Sci. Technol., 30:420-437 (1999).
[11]: Dubey P., Ghia U., Turkevich L. A., “Numerical investigation of sheath and aerosol flows in the flow combination section of a Baron fiber classifier”, Aerosol Sci. Technol., 48:896-905 (2014).
[12]: Ehara, K., Hagwood, C., Coakley, K. J., “Novel method to Classify Aerosol Particles According to Their Mass-to-Charge Ratio”, Aerosol Particle Mass Analyzer, J. Aerosol Sci, 27:217-234 (1996).
[13]: Olfert, J. S., Collings, N. “New Method for Particle Mass Classification: the Couette Centrifugal Particle Mass Analyser”, J. Aerosol Sci, 36:1338-1352 (2005).

1. A method for sorting micro- and nano-fibers in suspension in an aerosol likely to contain fibers of different sizes and possibly non-fibrous particles, comprising the following steps:
a/ charging of the particles in suspension in the aerosol, by unipolar ion diffusion;
b/ application of an electrical field between two electrically conductive flat surfaces, arranged substantially horizontally; the electrical field being directed in such a way that it exerts an electrostatic force on the charged particles, in opposition to the gravitational force;
c/ introduction of an aerosol flow from an input of a height corresponding to at least a part of the height of the space delimited between the two flat surfaces; the flow of the flow of air being non-turbulent in the space between flat surfaces; the flow of air circulating from and/or around the input to one or more outputs;
d/ recovery of the part of air flow charged with fibers and circulating at at least one of the outputs in the upper part of the space, or collection of the fibers on the flat surface on top which is in the form of a filtering membrane; the fibers recovered in the part of air flow or collected on the filtering membrane being sorted from the particles exhibiting a smaller form factor or that are non-fibrous initially present in the aerosol.

2. The sorting method according to claim 1, further comprising a step d′/ simultaneous with the step d/, whereby the part of air flow charged with non-fibrous particles and circulating at at least one of the outputs in the lower part of the space is recovered, or non-fibrous particles are collected on the lower flat surface which takes the form of a filtering membrane.

3. The sorting method according to claim 2, wherein the flat surfaces are rectangular flat plates, whereby:
the step c/ is performed by introduction of the aerosol into an input slit arranged in the space between plates and by circulation of a longitudinal flow of filtered air introduced on either side of the slit co-current with the aerosol flow;
the step d/ is performed by recovery of the part of the air flow charged with fibers in an output channel delimited between the top flat plate and a flow-separating wall arranged between the two flat plates;
if necessary, the step d′/ is performed by recovery of the part of air flow charged with non-fibrous particles in an output channel delimited between the lower flat plate and a flow-separating wall arranged between the two flat plates.

4. The sorting method according to claim 2, wherein the flat surfaces are full circular plates; whereby:
the step c/ is performed by introduction of the aerosol into an input slit arranged in the space between plates and by circulation of a radial flow of aerosol toward the center of the surfaces;
the step d/ is performed by recovery of the part of the air flow charged with fibers in an output duct produced in the axial extension in the circular plate on top thereof;
if necessary, the step d′/ is performed by recovery of the part of the air flow charged with non-fibrous particles in an output duct produced in the axial extension in the circular plate below the latter.

5. The sorting method according to claim 2, wherein at least the flat surface on top is a circular filtering membrane, whereby:
the step c/ is performed by introduction of the aerosol into an input slit arranged in the space between plates or in all the space between plates and by circulation of a radial flow of aerosol toward the center of the surfaces;
the step d/ is performed by collection of the fibers on the filtering membrane, the air flow without fibers collected being recovered in an output orifice above the filtering membrane;
if necessary, the step d′/ is performed by collection of the non-fibrous particles on a filtering membrane, the air flow without particles collected being recovered in an output orifice below the filtering membrane.

6. The sorting method according to claim 1, wherein the flat surfaces are the underside faces of two openwork disks with concave circular edge, arranged horizontally coaxially to one another defining a space between them; the input being a duct produced in the axial extension of the outer disk above the latter; the output being a duct produced in the axial extension of the inner disk above the latter; the underside face of the inner disk being at least partly a filtering membrane; whereby:
the step b/ is performed by application of the uniform electrical field between the two disks, the uniform electrical field being directed from bottom to top between the underside face of the outer disk and the bottom face of the inner disk;
the step c/ is performed by introduction of the aerosol from the input duct; the flow of the air flow being non-turbulent in the space between the two disks; the air flow circulating from the input duct to the output duct;
the step d/ is performed by collection of the fibers on the filtering membrane; the fibers collected on the filtering membrane being separated from the fibers of smaller form factors and that are non-fibrous initially present in the aerosol and having fallen through gravity in the space between faces below.

7. A device for implementing the sorting method according to claim 1, comprising:
two electrically conductive flat surfaces, arranged substantially horizontally;
means for applying an electrical field (E) between the two flat surfaces, from the bottom to the top;
means for introducing an aerosol flow of fibers in suspension in an aerosol likely to contain factor particles of different shapes or non-fibrous particles, from an input of a height corresponding to at least a part of the height of the space delimited between the two flat surfaces;
means for recovering the part of air flow charged with fibers and circulating at at least one of the outputs in the upper part of the space, or collection of the fibers on the flat surface above which is in the form of a filtering membrane.

8. The device according to claim 7, further comprising means for recovering the part of air flow charged with non-fibrous particles and circulating at at least one of the outputs in the lower part of the space, or collection of the particles on the flat surface below which is in the form of a filtering membrane.

9. The device according to claim 7, wherein the two flat surfaces are rectangular flat plates, the input being a slit arranged in the space between plates, the output being a channel delimited between the top flat plate and a flow-separating wall between the two flat plates.

10. The device according to claim 7, wherein the flat surfaces are solid circular plates, the input being a circular slit arranged in the space between plates, the output being a duct produced in the axial extension in the top circular plate.

11. The device according to claim 10, further comprising a duct for recovering the part of the flow containing the non-fibrous particles, the duct produced in the axial extension in the bottom circular plate.

12. The device according to claim 7, wherein the flat surfaces are circular surfaces, at least the top one of which comprises a filtering membrane; the input being a circular slit arranged in the space between circular surfaces, the output being a duct produced in the axial extension above the filtering membrane.

13. The device according to claim 7, wherein the flat surfaces are circular surfaces, at least the top one of which comprises a filtering membrane; the input being composed of all the space between circular surfaces, the output being a duct produced in the axial extension above the filtering membrane.

14. The device according to claim 7, wherein the flat surfaces are the bottom faces of two openwork disks with concave circular edge, arranged horizontally coaxially to one another defining a space between them; the input being a duct produced in the axial extension in the outer disk on top of the latter; the output being a duct produced in the axial extension of the inner disk on top of the latter; the bottom face of the inner disk being at least partly a filtering membrane.

15. The sorting method according to claim 1, further comprising detection and measurement of concentration in terms of number of fibers, in air.

16. The sorting method according to claim 15, further comprising detection and measurement of concentrations of WHO asbestos fibers.
